(19) United States
(12) Patent Application Publication
(10) Pub. No.: US 2013/0241282 A1
(43) Pub. Date: Sep. 19, 2013

(54) Structure For Routing High-Voltage Cable in Vehicle

(71) Applicants: Masayuki Ikeno, Shizuoka-ken (JP); Keisuke Katou, Shizuoka-ken (JP); Junka Iwasaki, Shizuoka-ken (JP)

(72) Inventors: Masayuki Ikeno, Shizuoka-ken (JP); Keisuke Katou, Shizuoka-ken (JP); Junka Iwasaki, Shizuoka-ken (JP)

(73) Assignee: SUZUKI MOTOR CORPORATION, Shizuoka-ken (JP)

(21) Appl. No.: 13/884,096

(22) PCT Filed: Feb. 23, 2011
(86) PCT No.: PCT/JP2011/053987

§ 371 Date: May 8, 2013

(51) Int. Cl. B60R 16/03

(52) U.S. Cl. CPC B60R 16/03
USPC 307/10.1; 307/9.1

(57) ABSTRACT

Objects of the present invention are to avoid effects on a high voltage cable as much as possible even in the case in which a vehicle is damage by an external force, to keep the number of fitting parts for protecting the high voltage cable small, and to make a front chamber as compact as possible. For this purpose, a wiring structure of a high voltage cable for a vehicle, including: a mounting unit provided in the front chamber in front of a dash panel; and a battery provided in rear of the dash panel, in which the high voltage cable connected to the battery is provided so as to run along the dash panel, a plurality of detail units configuring the mounting unit are aligned in the vehicle width direction in front of the dash panel, the rear surfaces of the detail units are formed so as to make a positional difference in the vehicle front and rear direction, and have different distances from the dash panel respectively, and the high voltage cable is wired so as to run in a dash panel portion facing to the rear surface of a detail unit on one side on which the distance from the dash panel is greater than that on another side.

### TECHNICAL FIELD

The present invention relates to a wiring structure for a high voltage cable for a vehicle.

More particularly, the present invention relates to a wiring structure for a high voltage cable used to connect a battery to a generator or a motor or an inverter in a high voltage energy system which is mounted in an electric vehicle (referred also to as an “EV”), the electric vehicle in a broad sense includes a hybrid electric vehicle (referred also to as an “HEV”) and a fuel cell hybrid electric vehicle (referred also to as an “FCV”). Furthermore, the present invention also relates to an arrangement structure on a vehicle for ensuring necessary performance in association with the passive safety of the vehicle.

### BACKGROUND ART

Among electric vehicles in a broad sense, particularly, the hybrid electric vehicle has mounted a large battery (referred also to as a “battery pack” or a “cell”) and a fuel tank in a rear portion of the vehicle body of the vehicle. Regarding the high voltage energy system, in wiring the high voltage cable used to connect a battery to a generator or a motor or an inverter, the high voltage cable is laid on a portion near the center in the vehicle width direction on the lower surface of a vehicle body floor so as to extend along the vehicle front and rear direction.

That is to say, as shown in FIGS. 8 and 9, a mounting unit 107 is provided in a front chamber (hereinafter, referred to as an “engine compartment”) 103 formed in front of a dash panel 102 of a vehicle 101, is provided in rear of right and left headlights (also described as “H/L's”) 104, and is provided between the right and left headlights 104.

In this configuration, as shown in FIG. 8, the mounting unit 107 is formed by a plurality of detail units. The detail units include an engine 111 configuring a power unit which is arranged on the right-hand side in the vehicle width direction in the engine compartment 103; a generator 112 which is arranged on the left-hand side of the engine 111, that is to say, near the center in the vehicle width direction; a driving motor (also described simply as a “motor”) 113 which is arranged on the rear side in the vehicle front and rear direction of the generator 112; and a gear case 114 which is arranged on the rear side in the vehicle front and rear direction of the engine 111 and is arranged on the right-hand side in the vehicle width direction of the driving motor 113. Furthermore, an inverter 115 is arranged on the left-hand side, in the vehicle width direction, of the generator 112 and the driving motor 113.

For example, the inverter 115 of the mounting unit 107 is connected to a battery (not shown, also referred to as a “cell”) by a high voltage cable 109.

That is to say, when this high voltage cable 109 is wired, as shown in FIGS. 8 and 9, the high voltage cable 109 connecting with the battery is laid so as to extend in a portion near the center in the vehicle width direction and in a lower portion in the upper and lower direction, from the rear toward the front in the vehicle front and rear direction.

The high voltage cable 109 rises upward in the rear of the driving motor 113 after passing through the dash panel 102 and reaching the engine compartment 103.

When reaching a height position higher than the generator 112 and the driving motor 113, the high voltage cable 109 runs from the portion near the center in the vehicle width direction toward the left-hand side, reaches the rear side of the inverter 115, and then, is connected to the inverter 115.

That is to say, the high voltage cable 109 is laid so as to protect the high voltage energy system including the high voltage cable 109 against an external force which is applied from all sides to the vehicle.

However, for example, at the front collision time at which an external force is applied to a front portion of the vehicle, as shown in FIG. 10, the engine compartment 103 is depressed, and the mounting unit 107 which is mounted in the engine compartment 103 and includes the engine 111, the generator 112, the driving motor 113, and the gear case 114, is retracted to the rear side in the vehicle front and rear direction, and the mounting unit 107 comes into contact with the dash panel 102.

At this time, the high voltage cable 109 is held between the mounting unit 107 and the dash panel 102 as indicated by the hatched portion shown in FIGS. 10 and 11, and therefore, there arises a problem that the high voltage cable 109 may be damaged.

As a solution to the above-described problem, it can be thought that the portion of the high voltage cable 109 which is located between the mounting unit 107 and the dash panel 102 is covered firmly with a protective member that includes a sheet metal cover, a resin protector, or the like.

On the other hand, in the case in which the generator, the driving motor, and the inverter are mounted crowded together in the engine compartment accommodating the power unit, a plurality of high voltage cables must be wired between the generator and the inverter and must be wired between the driving motor and the inverter, and the high voltage cables occupy a considerably large space even if the high voltage cables are wired in an orderly way so as to have the necessary minimum length.

In order to protect the high voltage cable from suffering damage, the high voltage cable is covered with a protective member having high strength and high rigidity.

On the hybrid electric vehicle mounted with an engine, it is necessary to provide a fuel supply system for supplying fuel to the engine and an exhaust system for exhausting combustion gas from the engine.

When the high voltage cable is wired, it has been considered to make the high voltage cable be apart from the fuel supply system and exhaust system.

The fuel supply system, the exhaust system, and the high voltage cable are arranged separately; for example, the exhaust system is disposed along a floor center tunnel, the fuel supply system is disposed on one floor of right and left floors with the center tunnel being held therebetween, and the high voltage cable is laid on the other floor thereof.

It is a concern to prevent interaction as much as possible, and it is a concern to ensure reliability in the ordinary specification range.

### CITATION LIST

### Patent Literature

PTL 1: Japanese Patent No. 3838505

### SUMMARY OF INVENTION

### Technical Problem

PTL 1 discloses a hybrid electric vehicle that is modified such that a motor generator, a battery, and the like are provided on a gasoline-fueled vehicle basically using an engine as a power unit so as to be added to the gasoline-fueled vehicle, whereby the driving can be assisted, or regenerative generation of electric power can be performed.

This vehicle is not deemed to be an electric vehicle because it cannot be run by a motor only; this vehicle is a hybrid electric vehicle.

This vehicle is mounted with a high voltage energy system which includes a battery, a generator or a motor, an inverter, and a high voltage cable, and also includes an engine and a fuel tank.

The change of vehicle body is restricted so as to be very small as a modified vehicle. However, when paying attention to the high voltage cable, the high voltage cable is laid under the fuel tank and the floor from the battery and inverter which are mounted at the rear, to the engine so as to be exposed externally, and as a result, necessary performance is ensured.

PTL 1 discloses a hybrid electric vehicle characterized by having a structure in which the high voltage cable is laid near a dash panel.

In the case in which an electric vehicle is configured as a base for a compact small-sized vehicle, a ratio which is to provide a passenger space in a portion near the vehicle center and is to ensure comfort, increases, and on the other hand, it is desirable that the engine compartment in the front portion of the vehicle be as small as possible.

In the case in which the engine, the generator, the driving motor, and the inverter are mounted crowded together in the engine compartment accommodating the power unit, the occupation space and the interference regarding arrangements of these components and furthermore layout of the high voltage cable, must be considered.

Even in the case in which the vehicle front portion is damaged by an external force, it is necessary to avoid effects exerted on the high voltage energy system as much as possible.

That is to say, the high voltage cable is prevented from being held between the components and from being damaged, and as a result, the probability of short circuit can be reduced significantly.

If the above-described protective member is provided between the components, there arises a problem of increased probability that the gap is narrowed, and the components come into contact with each other. Therefore, although this is unavoidable in the case in which the protective member is provided when it is always necessary for thermal insulation or the like, it is desirable to provide the protective member in an ample space avoiding the above-described location.

That is to say, the structure of the related art disclosed in FIGS. 8 and 9 causes the problem to arise.

In the wiring structure disclosed in Japanese Unexamined Patent Application Publication No. 2004-148851, the inverter and the like are not accommodated in the engine compartment (front chamber), and the generator and the driving motor are configured as one unit which is a motor generator. Therefore, the occupied space is small, even a smaller engine compartment has relatively surplus space, and necessary performance is ensured.

However, it is desirable to make further improvement.

Objects of the present invention are to avoid an influence on a high voltage cable as much as possible even in the case in which a vehicle suffers damage such that the vehicle is deformed greatly by an external force, are to keep the number of fitting parts for protecting the high voltage cable small, and are to make a front chamber accommodating a mounting unit, the high voltage cable, and the like as compact as possible.

### Solution to Problem

To achieve the above objects, the present invention provides a wiring structure for a high voltage cable for a vehicle, including a mounting unit provided in a front chamber which is arranged in the front of a dash panel; and a battery provided in the rear of the dash panel; wherein the high voltage cable is arranged along the dash panel, the high voltage cable being connected to the battery and extending toward the vehicle front portion; wherein a plurality of detail units configuring the mounting unit are aligned in the vehicle width direction in front of the dash panel; wherein the rear surfaces of the detail units are formed so as to make a positional difference in the vehicle front and rear direction, and the rear surfaces thereof have different distances from the dash panel respectively; and wherein the high voltage cable is wired so as to run in a dash panel portion facing to the rear surface of the detail unit on one side on which the distance from the dash panel is greater than that on another side.

### Advantageous Effects of Invention

As explained in detail above, according to the present invention, a wiring structure of a high voltage cable for a vehicle, including: a mounting unit provided in a front chamber which is arranged in front of a dash panel; and a battery provided in rear of the dash panel; wherein the high voltage cable is provided so as to run along the dash panel, the high voltage cable being connected to the battery and extending toward the vehicle front; wherein a plurality of detail units configuring the mounting unit are aligned in the vehicle width direction in front of the dash panel; wherein the rear surfaces of the detail units are formed so as to produce a positional difference in the vehicle front and rear direction, and the rear surfaces thereof have different distances from the dash panel respectively; and wherein the high voltage cable is wired so as to run in a dash panel portion facing to the rear surface of the detail unit on one side on which the distance from the dash panel is greater than that on another side.

Therefore, when the mounting unit moves to the rear, and comes into contact with the dash panel, a gap is ensured by the positional difference, and the high voltage cable can be prevented from being damaged. Furthermore, even when contact does not occur, a space can be ensured, interference can be avoided, and a work space can be maintained.

### BRIEF DESCRIPTION OF DRAWINGS

FIG. 1 is a schematic plan view of an engine compartment in front of a dash panel of a vehicle. (Embodiment)

FIG. 2 is a schematic front view taken along arrow mark C of FIG. 1. (Embodiment)

FIG. 3 is a schematic plan view of an engine compartment in front of a dash panel of a vehicle at the time of front collision. (Embodiment)

FIG. 4 is a schematic plan view of a vehicle. (Embodiment)

FIG. 5 is a bottom perspective view of a floor panel portion of a vehicle. (Embodiment)

FIG. 6 is a schematic left side view of an engine compartment in front of a dash panel of a vehicle. (Embodiment)

FIG. 7 is a schematic bottom plan view of an engine compartment portion in front of a dash panel of a vehicle. (Embodiment)

FIG. 8 is a schematic plan view of an engine compartment in front of a dash panel of a vehicle, showing a related art of the present invention.

FIG. 9 is a schematic front view taken along arrow mark A of FIG. 8.

FIG. 10 is a schematic plan view of an engine compartment in front of a dash panel of a vehicle at the time of front collision.

FIG. 11 is a schematic front view taken along arrow mark B of FIG. 10.

### DESCRIPTION OF EMBODIMENT

An embodiment of the present invention will now be described in detail with reference to the accompanying drawings.

### Embodiment

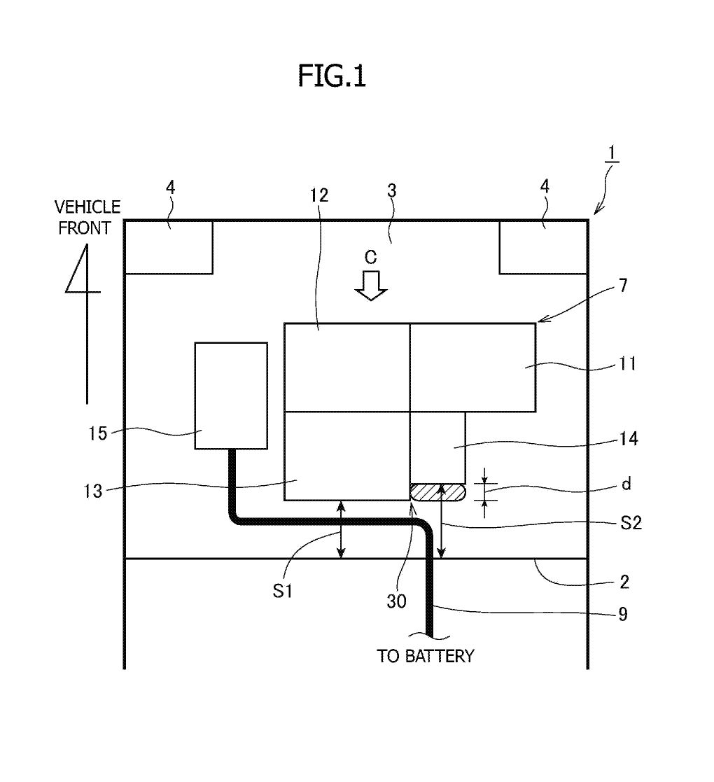

FIGS. 1 to 7 show the embodiment of the present invention.

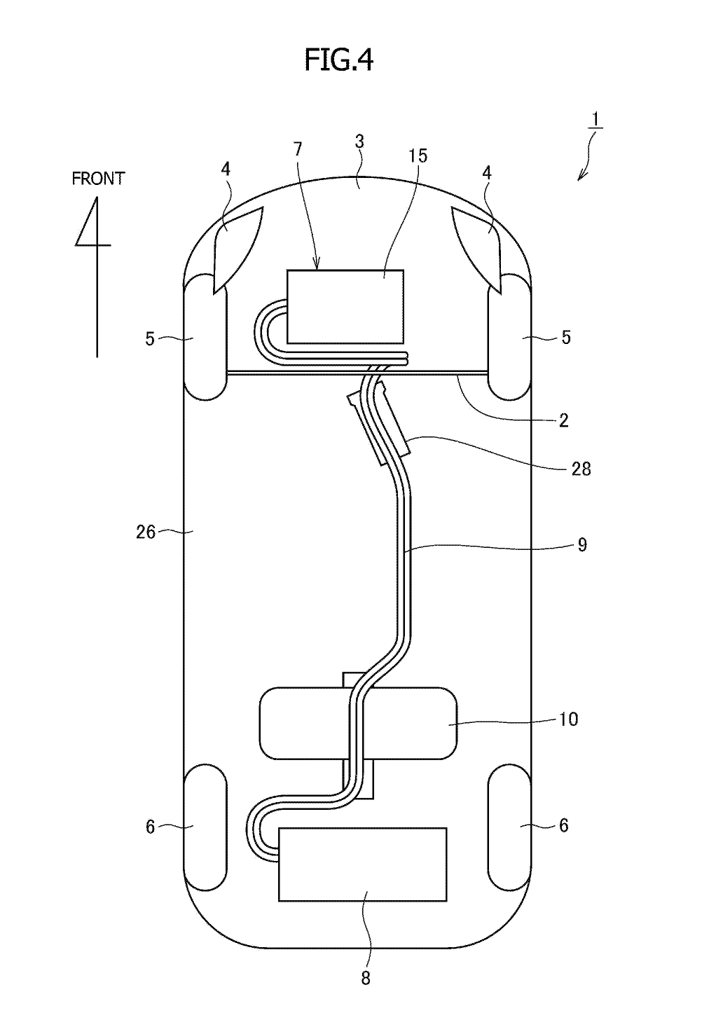

In FIGS. 4 to 6, reference numeral “1” denotes a vehicle, reference numeral “2” denotes a dash panel, reference numeral “3” denotes a front chamber, that is to say, an engine compartment in front of the dash panel 2 of the vehicle 1, reference numeral “4” denotes a headlight, reference numeral “5” denotes a front wheel, and reference numeral “6” denotes a rear wheel.

The engine compartment 3, which corresponds to the front chamber of the vehicle 1, includes: a mounting unit (capable of being referred also to as an “engine assy” or an “engine assembly”) 7; and a battery (referred also to as a “battery pack” or a “cell”) 8 which is arranged in rear of the dash panel 2. A high voltage cable 9 is connected to the battery 8, extends toward the vehicle front portion, and rises along the dash panel 2.

That is to say, in the wiring structure of the high voltage cable 9 for the vehicle 1, as shown in FIG. 4, an inverter 15, described later, is disposed in the mounting unit 7 which is provided in the engine compartment 3 of the vehicle 1. On the other hand, the battery 8 is provided between the rear wheels 6 at the rear of the vehicle 1, and is provided in a cargo compartment (not shown) which is arranged above a floor panel (referred also to as a “vehicle body floor”) 26, described later. When the battery 8 and the inverter 15 of the mounting unit 7 are connected to each other by the high voltage cable 9, the high voltage cable 9 is laid in a portion in the center in the vehicle width direction from the battery 8, reaches the dash panel 2 through the upper surface of a fuel tank 10, and is turned so as to rise along the dash panel 2 after passing through the dash panel 2, and as a result, the high voltage cable 9 is connected to the inverter 15 in the mounting unit 7.

A plurality of detail units configuring the mounting unit 7 are provided so as to be arranged in the vehicle width direction in front of the dash panel 2.

For convenience, as shown in FIG. 1, the detail units configuring the mounting unit 7 comprises: an engine (referred also to as an “internal-combustion engine”) 11 configuring a power unit arranged on the right-hand side in the vehicle width direction of the engine compartment 3; a generator 12 being arranged on the left-hand side of the engine 11, that is to say, near the center in the vehicle width direction; a driving motor (also described simply as a “motor”) 13 being arranged on the rear side in the vehicle front and rear direction of the generator 12 of the generator 12; and a gear case 14 being arranged on the rear side in the vehicle front and rear direction of the engine 11 and being arranged on the right-hand side, in the vehicle width direction, of the driving motor 13 to output a driving force which is input from the driving motor 13 toward the front wheels 5. The inverter 15 is arranged on the left-hand side, in the vehicle width direction, of the generator 12 and the driving motor 13.

The engine 11, the generator 12, the driving motor 13, and the gear case 14 which are configured as detail units, are accommodated and mounted in the engine compartment 3.

The drive and stop of the engine 11 can be changed over at optional timing during the running of the vehicle 1.

The generator 12 is drivingly connected to the engine 11 mechanically.

The engine 11 and the generator 12 are formed as an integrated unit.

The driving motor generates a vehicle driving force.

The gear case 14 transmits power following the driving motor 13.

The driving motor 13 and the gear case 14 are formed as an integrated unit.

These components constitute a true power unit for driving the vehicle 1.

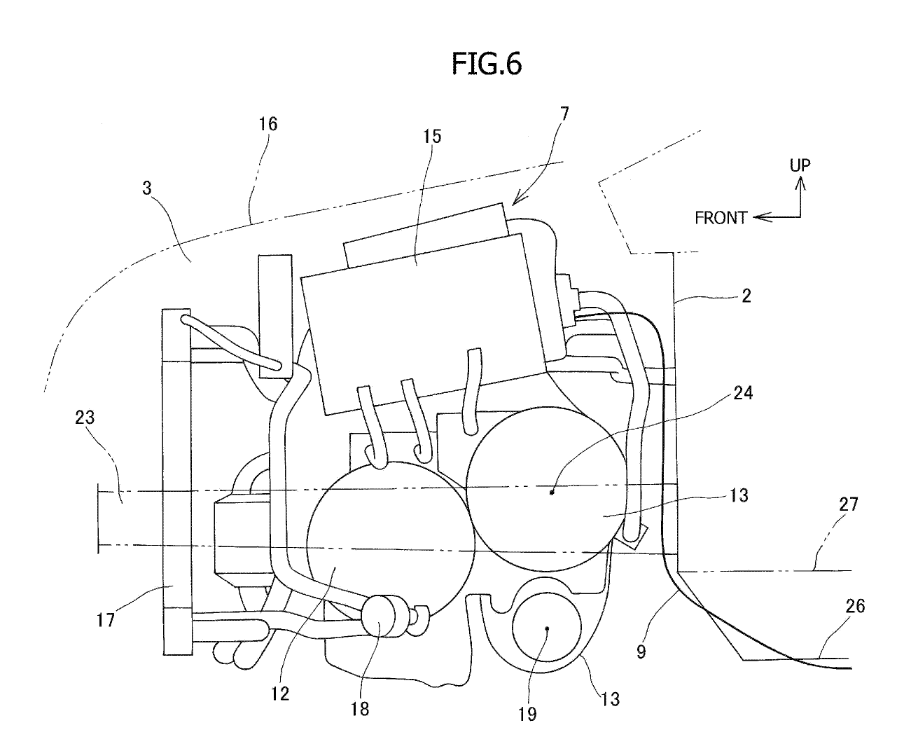

Here, the relationship between mounting positions of these parts is explained in detail. As shown in FIG. 6, the inverter 15 is arranged in an upper portion arranged inside of an engine hood 16 of the engine compartment 13, and the inverter 15 is connected to the battery 8 in the high voltage energy system to control the driving motor 13.

This inverter 15 is arranged and mounted so as to cover the upper sides of both of the generator 12 which is positioned on the front side in the vehicle front and rear direction, and the driving motor 13 which is positioned on the rear side of the generator 12.

Above the engine 11, accessories (not shown) of an intake system are disposed.

At the mounting time, all of these parts are assembled together with the mounting unit 7, and are mounted collectively.

Although not shown in detail, as shown in FIG. 6, a radiator 17 for an engine cooling system, a radiator (not shown) for a generator or a driving motor cooling system, a condenser (not shown) for an air-conditioning system, and the like, are disposed in a front portion of the engine compartment 3. In the lower portion of the engine compartment 3, a motor-driven compressor (not shown) for the air-conditioning system, a water pump 18 for the generator or a driving motor cooling system, and the like, are disposed.

In this configuration, the generator or a driving motor cooling system is configured so as to cool the generator 12, the driving motor 13, and the inverter 15.

The power unit that is to generate a vehicle driving force and is to transmit the driving force, is formed by the driving motor 13 and the gear case 14.

Although not shown in the drawings, the driving force is transmitted from the gear case 14 to an axle shaft 19.

While considering the balance, vibrations, and the like of the right and left driving shafts (not shown), the driving force is transmitted via an intermediate shaft (not shown) as necessary.

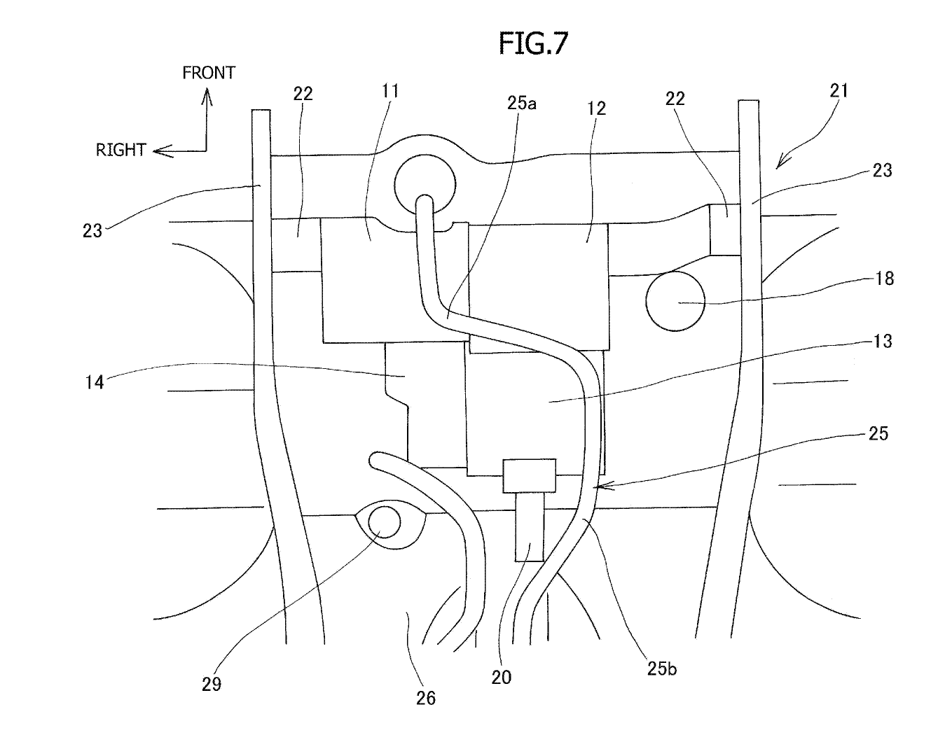

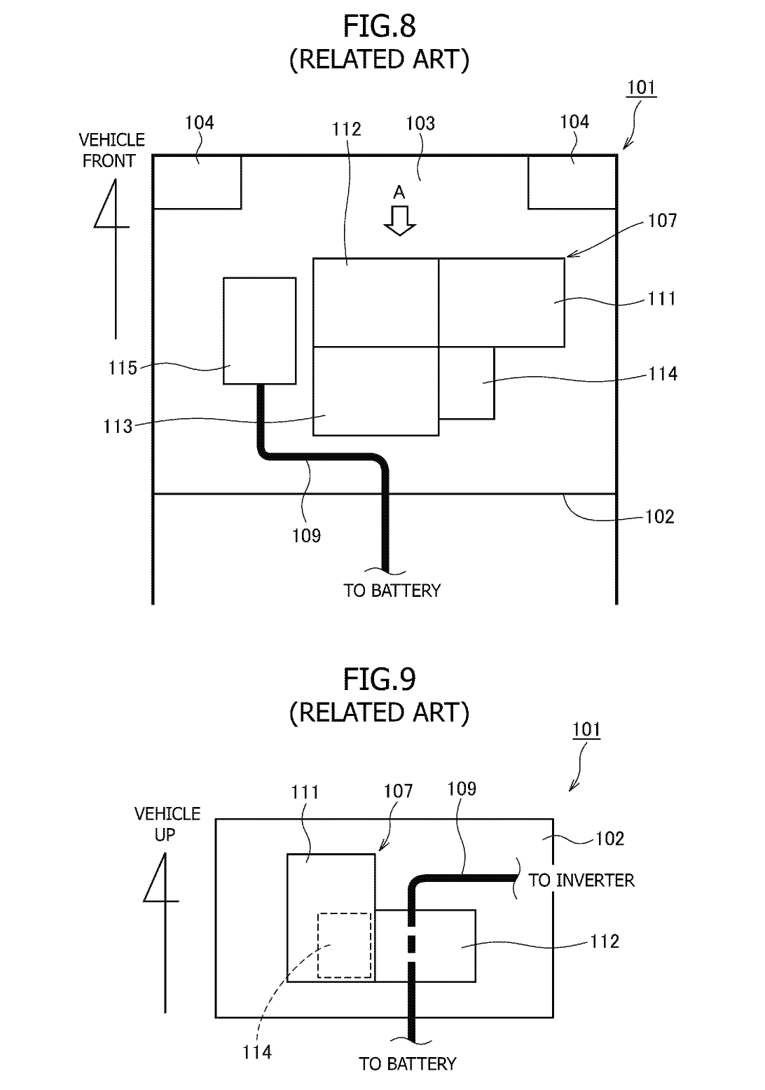

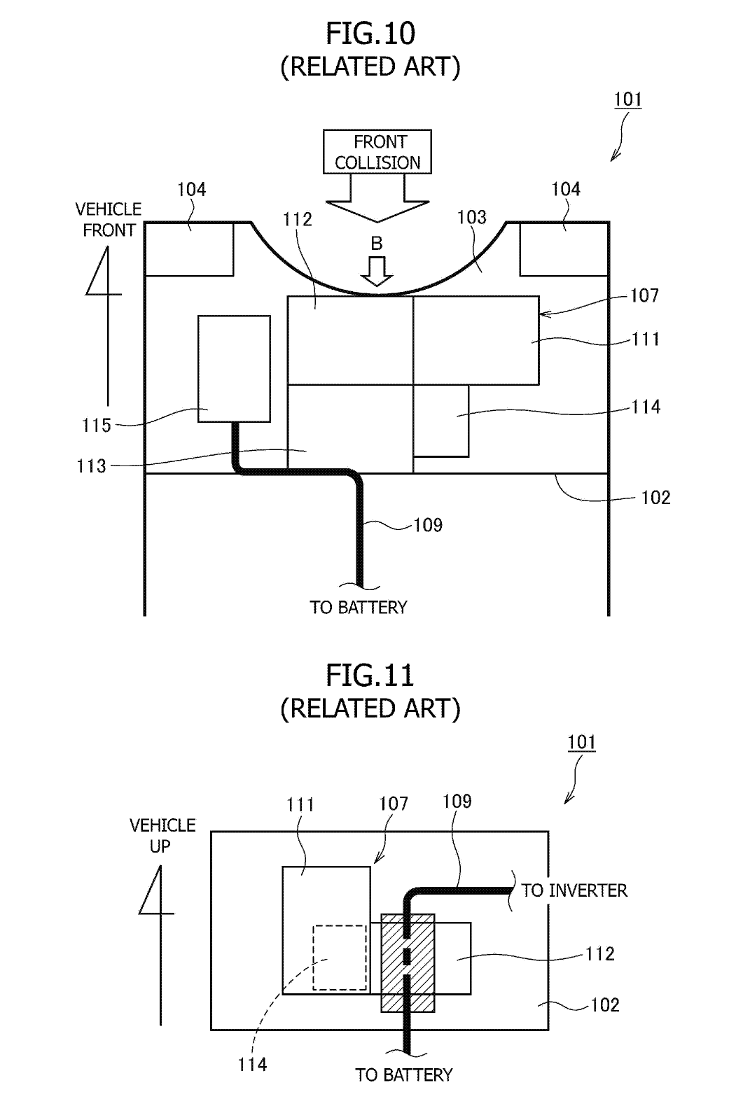

As shown in FIGS. 6 and 7, the driving motor 13 and the gear case 14 are fixed to the upper surface side of a subframe (not shown, also referred to as a “suspension frame”) of a vehicle body 21 via a rear mount 20 of which vibrations are isolated by an elastic member.

The engine 11 and the generator 12 do not generate the vehicle driving force directly, that is to say, it can be said that the engine 11 and the generator 12 do not configure the power unit.

The engine 11 and the generator 12 can generate the electric power for driving the power unit.

That is to say, the vehicle 1 is of a series-type hybrid driving system.

If the engine 11 and the generator 12 are omitted, the vehicle 1 becomes an electric vehicle in a narrow sense.

If specific conditions are met, for example, if the charge amount of the battery 8 decreases, the engine 11 and the generator 12 are used such that the engine 11 is started and driven to turn the generator 12, and as a result, electric power is generated.

The engine 11 and the generator 12 are arranged such that their lengthwise directions are directed to the vehicle width direction, and as shown in FIG. 7, the engine 11 and the generator 12 are fixed to side frames 23 of the vehicle body 21 via mounts 22 at both of the right and left ends thereof.

As shown in FIG. 7, a crankshaft (not shown) of the engine 11 and a rotating shaft (not shown) of the generator 12 are positioned so as to be lower than a rotating shaft 24 of the driving motor 13. This configuration contributes to keeping of the centers of gravity in the engine 11 and the generator 12 at lower positions.

The combination of the engine 11 and the generator 12, and the combination of the driving motor 13 and the gear case 14, are connected to each other so as to be mechanically integrated in a portion in which these combinations are closest to each other, and these combinations are mounted to the vehicle 1 via three mounts including the right and left mounts 22 and the rear mount 20.

The combinations are usually supported stably by the mounts 20, 22, and 22. On the other hand, the combinations are configured such that if a load caused by an external force is applied from the front, the unit in which the combination of the engine 11 and the generator 12 and the combination of the driving motor 13 and the gear case 14 are integrated (for convenience, referred to as the “mounting unit 7”), can move almost horizontally toward the vehicle rear portion.

Although not shown in the drawings in detail, the rotating shaft 24 of the driving motor 13 is positioned so as to be higher than the crankshaft of the engine 11 and the rotating shaft of the generator 12 as shown in FIG. 7.

As a result, in plan view (also referred to as “bottom view”), the generator 12 and the driving motor 13 are arranged such that a casing (not shown) of the generator 12 and a casing (not shown) of the driving motor 13 overlap partially one on the other in the upper and lower direction. Therefore, the longitudinal length of the mounting unit 7 can be short, and furthermore, the movement dimension with respect to the mounting space of the vehicle body 21 can be made large. In particular, the dimension between the dash panel 2 and the casing of the driving motor 13 is made large.

The gear case 14 has an input shaft (not shown) coaxially with the rotating shaft 24 of the driving motor 13 in the upper portion thereof, and the gear case 14 has an output shaft (not shown) connecting with the axle shaft 19 in the lower portion thereof.

In the gear case 14, a reduction gear (not shown) and a working device (not shown) are accommodated.

The external shape of the gear case 14 can be made so as to be relatively long in the upper and lower direction and short in the front and rear direction.

Under the driving motor 13, the intermediate shaft is provided.

As shown in FIG. 7, an exhaust pipe 25 configuring the exhaust system of the engine 10, runs under the engine 10, forms two-stage crank-like bend portions 25a and 25b, and extends to the vehicle rear passing through a center tunnel 27 of the floor panel (also referred to as the “vehicle body floor”) 26.

The exhaust pipe 25 takes a surrounding shape so as to go around the gear case 14 due to the two-stage crank-like bend portions 25a and 25b.

In this configuration, by increasing the distance between the two-stage crank-like bend portions 25a and 25b of the exhaust pipe 25 and the gear case 14, the influence of radiation heat can be reduced.

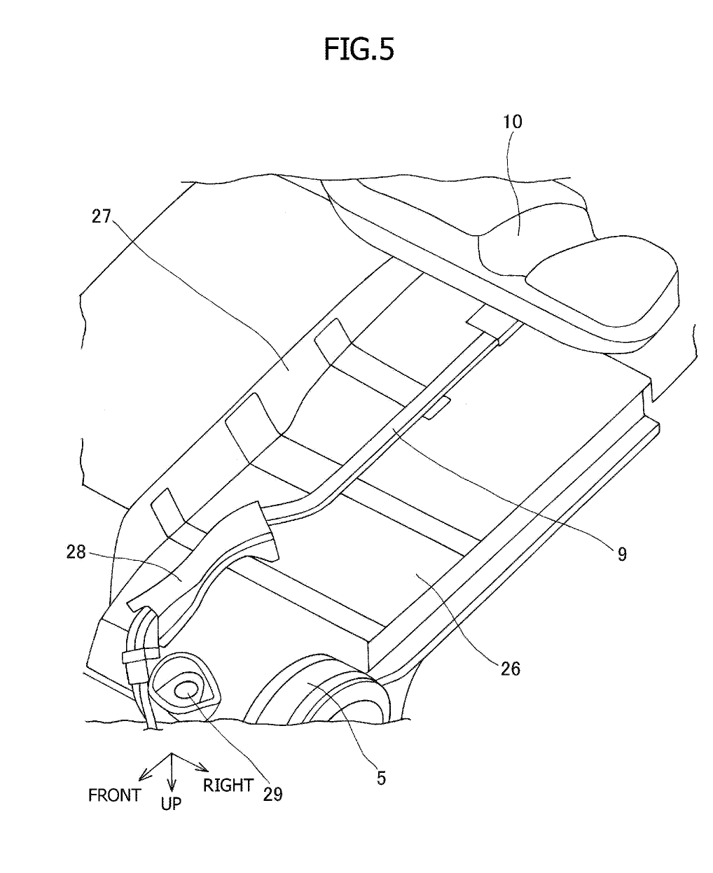

As shown in FIGS. 4 and 5, the high voltage cable 9 extends from one end of the battery 8 to the vehicle front portion above the floor panel 26, is then bent to the vehicle center direction so as to extend along the periphery of the battery 8, and extends again toward the vehicle front when reaching a portion near the center in the vehicle width direction.

In this configuration, as shown in FIGS. 4 and 5, the high voltage cable 9 extending toward the vehicle front is attached to the floor panel 26 by a protective cover 28 in a portion in rear of the dash panel 2, that is to say, in a space portion having sufficient room.

As shown in FIGS. 5 and 7, in the portion of the protective cover 28, since a steering attachment part 29 is formed near the right front wheel 5 of the vehicle 1, the high voltage cable 9 is curved so as to go around the steering attachment part 29.

In the vicinity of a portion in which the vehicle rear portion of the floor panel 26 rises from the vehicle front portion thereof, the high voltage cable 9 penetrates the floor panel 26 from the upper side of the floor panel 26 to the lower side thereof (refer to FIG. 6), and furthermore the high voltage cable 9 extends to the vehicle front and rear direction along the lower surface of the vehicle front portion of the floor panel 26.

On the lower surface of the vehicle front portion of the floor panel 26, the high voltage cable 9 extends in the vehicle front and rear direction so as to run along the side frame 23 and the center tunnel 27 between these components.

At a position at which the vehicle front portion of the floor panel 26 connects with the dash panel 2, the high voltage cable 9 partially enters into the end portion space of the center tunnel 27, and then extends along the surface of the dash panel 2 which faces to the back surface of the gear case 14.

A subframe is provided at a position under the dash panel 2, and this position is also a position at which the rear mount 20 is provided.

In the internal space of the center tunnel 27, and also in a space including a space held between the center tunnel 27 and the subframe, the high voltage cable 9 is arranged so as to avoid interference with a steering rack (not shown).

The high voltage cable 9 is laid so as to be separate from the exhaust pipe 25 to the opposite side in the vehicle width direction so that thermal expansion and interference in a narrow and limited space are avoided.

At the same time, the high voltage cable 9 extends from a high position above the internal space of the center tunnel 27 to the front of the front surface of the dash panel 2, and as a result, a length range held between the dash panel 2 and the mounting unit 7 is decreased. Therefore, problems are prevented in that the high voltage cable 9 is held between the mounting unit 7 and the dash panel 2 when a space between these components is decreased by deformation.

That is to say, in the present invention, the detail units are provided such that the rear surfaces thereof are formed so as to produce a positional difference 30 in the vehicle front and rear direction, and are formed so as to make the distances from the dash panel 2 different, and the high voltage cable 9 is laid so as to run in a dash panel 2 portion facing to the rear surface of the detail unit on one side on which the distance from the dash panel 2 is greater than that on another side.

When describing more specifically, in the case in which the detail units are the engine 11, the generator 12, the driving motor 13, and the gear case 14, the positional difference 30 is made between the rear surfaces of the driving motor 13 and the gear case 14 which are positioned on the rear side in the vehicle front and rear direction.

In this case, the positional difference 30 is made such that the distance from the dash panel 2 to the rear surface of the gear case 14 is greater than the distance from the dash panel 2 to the rear surface of the casing of the driving motor 13.

That is to say, referring to FIG. 1, when defining the distance between the rear surface of the driving motor 13 and the front surface of the dash panel 2 as S1, and defining the distance between the rear surface of the gear case 14 and the front surface of the dash panel 2 as S2, the relationship

S1>S2

is satisfied, and the positional difference 30 is made by the distances S1 and S2.

A difference d (refer to the hatched portion in FIG. 1) between the distance S2 and the distance S1, which forms the positional difference 30, is set at a dimension not less than the maximum external shape dimension of the high voltage cable 9.

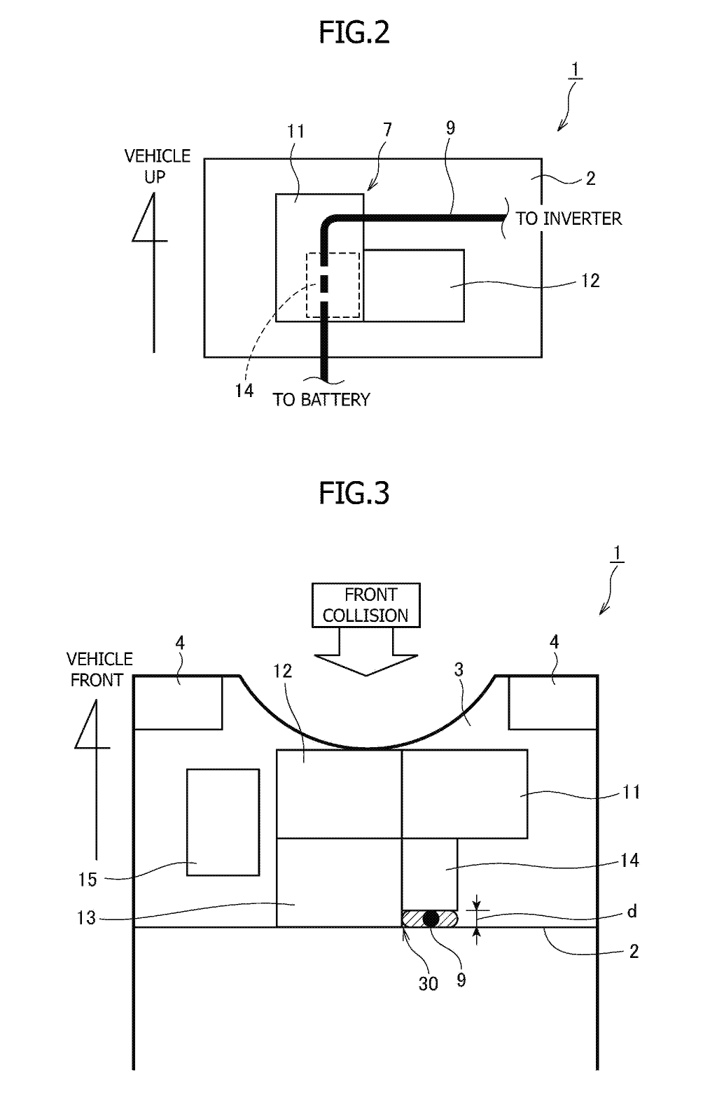

As shown in FIGS. 1 and 2, the high voltage cable 9 is laid so as to run in a dash panel 2 portion facing to the rear surface of the detail unit on one side on which the distance from the dash panel 2 is greater than that on another side, that is to say, the high voltage cable 9 is laid so as to run in the dash panel 2 portion facing to the rear surface of the gear case 14 having the distance S2.

By doing this, for example, at the front collision time at which an external force is applied from the vehicle front to the vehicle 1, as shown in FIG. 3, the mounting unit 7 is moved to the vehicle rear portion, the distance S1 is made zero, and the rear surface of the driving motor 13 of the mounting unit 7 is brought into contact with the front surface of the dash panel 2.

At this time, the whole of the unitized mounting unit 7 comes into contact with the front surface of the dash panel 2, as indicated by the hatched portion in FIG. 3, between the rear surface of the gear case 14 and the front surface of the dash panel 2 which faces the rear surface of the gear case 14, and therefore, a gap formed by the difference d between the distance S2 and the distance S1 is formed.

Even in the case in which an external force stronger than that at the above-described front collision time is applied from the vehicle front of the vehicle 1, the whole of the unitized mounting unit 7 retracts in the state in which a gap formed by the difference d between the distance S2 and the distance S1 is ensured between the rear surface of the gear case 14 and the front surface of the dash panel 2 which faces to the rear surface of the gear case 14, and therefore, problems of disappearing gap are minimized.

Therefore, when the mounting unit 7 moves to the rear and comes into contact with the dash panel 2, the gap is ensured by the positional difference 30, and as a result, the high voltage cable 9 can be prevented from being damaged. Even in the case in which the contact does not occur, the space can be ensured, the interference can be avoided, and a work space can be maintained. Furthermore, a component, such as a strong sheet metal cover or resin protector for collision guard can be omitted or be simplified.

The detail units of the mounting unit 7 is formed by the driving motor 13 necessary as an electric vehicle and the gear case 14 necessary in association with the driving motor 13 so that the mounting unit 7 can be used for many types of vehicles.

Furthermore, the driving motor 13 having the outside diameter of a cylindrical shape due to the inclusion of a rotating body is used, and the gear case 14 having a high degree of freedom is accommodated in the casing having a shape of specific dimensions so that the mounting unit 7 can be used easily without the need for special and new techniques.

The casing of the driving motor 13 of the mounting unit 7 is provided so as to be positioned in the center portion in the vehicle width direction, and the gear case 14 is formed so as to be long in the upper and lower direction with the input shaft which is higher than the output shaft, and is formed so as to be short in the vehicle front and rear direction. Therefore, the rotating shaft 24 of the driving motor 13 is connected to the input shaft of the gear case 14.

Therefore, the position of the driving motor 13 is high, and the driving motor 13 faces to the front surface of the dash panel 2, so that when the mounting unit 7 moves to the rear, the mounting unit 7 can be reliably brought into contact with the front surface of the dash panel 2, and a load can be received by the dash panel 2 stably and surely.

Furthermore, the dash panel 2 has an opening structure which is a start position of the center tunnel 27, at a portion connecting with the floor panel 26, and the rear surface of the casing of the driving motor 13 faces a portion near the upper portion of the opening structure. On the other hand, the high voltage cable 9 passes through the opening of the center tunnel 27 from a lower portion of the floor panel 26, and is laid to the front surface of the dash panel 2 which faces to the rear surface of the gear case 14.

Therefore, since the high voltage cable 9 is brought into contact with the highly rigid dash panel 2 by the center tunnel 27, the high voltage cable 9 can withstand a load, and the gap formed by the positional difference 30 can be maintained.

For this reason, the high voltage cable 9 can be introduced from a high position of the opening, and as a result, the high voltage cable 9 can be prevented from being damaged.

The dimension of the range overlapping on the rear surface of the mounting unit 7 (in particular, the rear surface of the gear case 14) can be made short by the wiring of the high voltage cable 9. Furthermore, since the high voltage cable 9 can be introduced from a high position of the opening into the engine compartment 3, the range in which the protective member and the like are provided can be reduced.

The interference with the steering rack can be avoided.

The present invention is not limited to the above-described Embodiment, and various modifications and changes can be made.

For example, in the Embodiment of the present invention, explanation has been given of the series-type hybrid electric vehicle. However, if the arrangement is made such that the casing of the driving motor for generating the driving force of vehicle and the gear case formed by a reduction gear are mounted in a space in front of the dash panel in the same way as in this Embodiment, the present invention may be applied to a pure electric vehicle and a hybrid electric vehicle having any other driving system (for example, a parallel system or a split system).

Furthermore, the combination of the engine and the generator, and the combination of the driving gear and the gear case can be mounted in a compact manner by unitization. However, since the driving force is not transmitted therebetween, these combinations need not necessarily be connected mechanically.

That is to say, the mounting unit may be formed by the driving motor and the gear case.

### REFERENCE NUMERALS

1 Vehicle
2 Dash panel
3 Engine compartment
7 Mounting unit
8 Battery
9 High voltage cable
10 Fuel tank
11 Engine
12 Generator
13 13 Driving motor
14 Gear case
15 Inverter
23 Side frame
24 Rotating shaft of driving motor
25 Exhaust pipe
26 Floor panel (referred also to as “vehicle body floor”)
27 Center tunnel
28 Protective cover
29 Steering attachment part
30 Positional difference
S1 Distance between rear surface of driving motor and front surface of dash panel
S2 Distance between rear surface of gear case and front surface of dash panel
d Difference between distance S2 and distance S1

1. A wiring structure of a high voltage cable for a vehicle, comprising:
a mounting unit provided in the front chamber which is arranged in front of a dash panel; and
a battery provided in the rear of the dash panel;
wherein the high voltage cable is arranged along the dash panel, the high voltage cable being connected to the battery and extending toward a vehicle front portion;
wherein a plurality of detail units configuring the mounting unit, are aligned in the vehicle width direction in front of the dash panel;
wherein the rear surfaces of the detail units are formed so as to make a positional difference in the vehicle front and rear direction, and the rear surfaces thereof have different distances from the dash panel respectively; and
wherein the high voltage cable is wired so as to be arranged in a dash panel portion facing the rear surface of the detail unit on one side on which the distance from the dash panel is greater than that on another side.

2. The wiring structure of the high voltage cable for the vehicle according to claim 1, wherein
the detail units correspond to a driving motor for generating a driving force of the vehicle, and a gear case for outputting the driving force which is input from the driving motor toward the wheels, respectively, and
the positional difference is provided such that the rear surface of the gear case is more distant from the dash panel than the rear surface of the casing of the driving motor.

3. The wiring structure of the high voltage cable for the vehicle according to claim 2, wherein
the casing of the driving motor of the mounting unit is positioned in the center portion in the vehicle width direction,
the gear case is formed so as to be long in the upper and lower direction in a condition in which the input shaft is higher than the output shaft, and furthermore, the gear case is formed so as to be short in the vehicle front and rear direction, and
as a result, the rotating shaft of the driving motor is connected to the input shaft of the gear case.

4. The wiring structure of the high voltage cable for the vehicle according to claim 1, wherein
the dash panel has an opening structure which corresponds to a start position of a center tunnel, at a portion connecting with a floor panel, and
the rear surface of the casing of the driving motor faces to a portion near the upper portion of the opening structure, and on the other hand, the high voltage cable passes through the opening of the center tunnel from a lower portion of the floor panel, and is wired to the front surface of the dash panel which faces to the rear surface of the gear case.
